(19) United States
(12) Patent Application Publication
(10) Pub. No.: US 2022/0295785 A1
(43) Pub. Date: Sep. 22, 2022

(54) SHEAR STABLE COMPOSITION FOR SPRAY DRIFT CONTROL

(71) Applicant: BASF SE, Ludwigshafen am Rhein (DE)

(72) Inventors: Timothy H. Anderson, Cincinnati, OH (US); Andrew P. Chiromo, Cincinnati, OH (US); Dean A. Oester, Cincinnati, OH (US)

(21) Appl. No.: 17/624,875

(22) PCT Filed: Jul. 8, 2020
(86) PCT No.: PCT/EP2020/069237

§ 371 Date: Jan. 5, 2022

Related U.S. Application Data
(60) Provisional application No. 62/872,824, filed on Jul. 11, 2019.

(51) Int. Cl. A01N 25/06; A01N 57/20

(52) U.S. Cl. CPC A01N 25/06; A01N 57/20

(57) ABSTRACT

Described herein is an aqueous composition including at least one polymer P1), at least one additive and at least one pesticide or salt thereof. Also described herein is a method for reducing spray drift, the method including spraying the aqueous composition onto a tract of land either prior to planting an agricultural crop or pre- or post-harvest of an agricultural crop. The aqueous composition is stable to shear.

### FIELD OF THE INVENTION

The present invention relates to an aqueous composition comprising at least one polymer P1), at least one additive and at least one pesticide or salt thereof. The present invention further relates to a method for reducing spray drift, the method comprising spraying the aqueous composition onto a tract of land either prior to planting an agricultural crop or pre- or post-harvest of an agricultural crop. The aqueous composition of the present invention is stable to shear.

### BACKGROUND OF THE INVENTION

Use of pesticides is essential in farming and agricultural industries. In these industries, the pesticides reduce the presence of harmful organisms and plants (such as weeds) that decrease crop yields and crop quality. When pesticides are applied, it is aimed at a specific target, and expected to reach a specific target, such as a plant. When a pesticide travels to areas where it is not needed or wanted, (i.e., when the pesticide “drifts”), unwanted consequences may result. Almost every pesticide, upon spray application, produces some amount of drift off the target area. Drift is affected by factors such as the formulation of the pesticide, the amount of the pesticide sprayed, the application method, the weather, and the auxiliaries which are present in the spray solution. More specifically, drift is the movement of the pesticide through the air away from the intended target. The drift can be in the form of water or liquid droplets.

Spray drift typically describes drift that occurs during or shortly after spraying of the pesticide on the target. Application is, for example, accomplished using ground spraying equipment or via aerial spraying. Spray drift often occurs when wind blows the pesticide off the intended target.

In the case of sprayable pesticide compositions, certain polymers are used as anti-drift or drift reduction agents in order to prevent the formation of liquid droplets that are too small to control their application within the desired confines. However, under shear or high shear conditions such as those found in spray and pump systems used for spraying these compositions, the effectiveness of the polymers to control spray drift is reduced, thereby permitting the formation of “too-small” droplets. When these small droplets are allowed to form, they are easily subjected to “drift” which carries them outside of the intended application area. Not only is this inefficient in that the intended application area does not receive the intended amount of product, but the droplets in the drift can be detrimental to the adjacent crops, land, and water sources.

Accordingly, it is an object of the presently claimed invention to provide a composition that not only improves the performance of anti-drift or drift reduction agents such as drift reducing polymers or copolymers but also retains their ability to control spray drift even under high shear conditions.

### SUMMARY OF THE INVENTION

Surprisingly, it was found that adding certain additives to the aqueous composition comprising polymer and pesticide improves the shear stability of the polymers resulting in the retention of their drift control properties, even under high shear, by controlling the hydrodynamic volume of the polymer.

Thus, in an aspect, the present invention relates to an aqueous composition comprising

a. at least one polymer P1) that is a polymerization reaction product of a monomer composition M1) comprising at least one monomer A) selected from α,β-ethylenically unsaturated mono- and dicarboxylic acids, α,β-ethylenically unsaturated mono- and dicarboxylic acid esters, salts of α,β-ethylenically unsaturated mono- and dicarboxylic acids, anhydrides of α,β-ethylenically unsaturated mono- and dicarboxylic acids, amides of a α,β-ethylenically unsaturated mono- and dicarboxylic acids, unsaturated sulfonic acids, salts of unsaturated sulfonic acids, unsaturated phosphonic acid, salts of unsaturated phosphonic acids and mixtures thereof,

b. at least one additive selected from the group of

(i) poly(C₂-C₄)alkylene glycol mono-(C₈-C₂₂)-carboxylic acid ester of general formula (I)

R₁—CO-(AO)_{q}—H (I)

wherein

R₁ is linear or branched, unsubstituted or substituted C₈-C₂₂-alkyl or linear or branched, unsubstituted or substituted C₈-C₂₂ alkenyl;

AO is identical or different, selected from CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O or CH₂—CH(C₂H₅)—O

q is a natural number from 1 to 40; and

(ii) alkoxylated alkylamine of general formula (II)

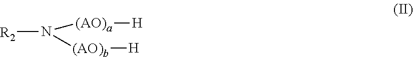

wherein

R₂ is linear or branched, unsubstituted or substituted C₈-C₂₂-alkyl or linear or branched, unsubstituted or substituted C₈-C₂₂ alkenyl;

AO is identical or different, selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O or CH₂—CH(C₂H₅)—O,

a is a natural number from 1 to 30; and

b is a natural number from 1 to 30, with the proviso that 2≤a+b≤40;

(iii) alkoxylated triglyceride; and

c. at least one pesticide, or a salt thereof.

In another aspect, the present invention is directed to a shear stable aqueous composition wherein upon spraying of said aqueous composition to form droplets, less than 5% of said droplets have volume mean diameter (VMD) of <141 μm as determined using ASTM E 2798-11, a Malvern Spray Tech droplet analyser, and TTI11004-VP TeeJet Spray Tip Nozzle.

In another aspect, the presently claimed invention is directed to a method of forming an aqueous composition comprising the steps of combining at least one polymer P1), at least one additive (b) and at least one pesticide (c).

In yet another aspect, the presently claimed invention is directed to the use of the aqueous composition, as described above, for controlling spray drift.

In another aspect, the presently claimed invention is directed to an agricultural kit comprising, as separate components, (a) the at least one Polymer P1); b) the at least one additive and c) the at least one pesticide.

### DETAILED DESCRIPTION OF THE INVENTION

Before the present compositions and formulations of the invention are described, it is to be understood that this invention is not limited to compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment but may refer to the same embodiment. Further, as used in the following, the terms “preferably”, “more preferably”, “even more preferably”, “most preferably” and “in particular” or similar terms are used in conjunction with optional features, without restricting alternative possibilities. Thus, features introduced by these terms are optional features and are not intended to restrict the scope of the claims in any way.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the presently claimed invention, and form different embodiments, as would be understood by those in the art. For example, in the appended claims, any of the claimed embodiments can be used in any combination.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Furthermore, the ranges defined throughout the specification include the end values as well i.e. a range of 1 to 10 implies that both 1 and 10 are included in the range. For the avoidance of doubt, the applicant shall be entitled to any equivalents according to the applicable law.

Certain terms are first defined so that this disclosure can be more readily understood. Unless defined otherwise, all technical and scientific terms used herein have the same meaning as commonly understood by one of ordinary skill in the art to which embodiments of the invention pertain.

In an aspect, the present invention relates to an aqueous composition comprising

a. at least one polymer P1) that is a polymerization reaction product of a monomer composition M1) comprising at least one monomer A) selected from α,β-ethylenically unsaturated mono- and dicarboxylic acids, α,β-ethylenically unsaturated mono- and dicarboxylic acid esters, salts of α,β-ethylenically unsaturated mono- and dicarboxylic acids, anhydrides of α,β-ethylenically unsaturated mono- and dicarboxylic acids, amides of α,β-ethylenically unsaturated mono- and dicarboxylic acids, unsaturated sulfonic acids, salts of unsaturated sulfonic acids, unsaturated phosphonic acid, salts of unsaturated phosphonic acids and mixtures thereof,

b. at least one additive selected from the group of

(i) poly(C₂-C₄)alkylene glycol mono-(C₈-C₂₂)-carboxylic acid ester of general formula (I)

R₁—CO-(AO)_{q}—H (I)

wherein

R₁ is linear or branched, unsubstituted or substituted C₈-C₂₂-alkyl or linear or branched, unsubstituted or substituted C₈-C₂₂ alkenyl;

AO is identical or different, selected from CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O or CH₂—CH(C₂H₅)—O

q is a natural number from 1 to 40;

(ii) alkoxylated alkylamine of general formula (II)

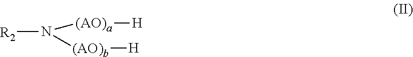

wherein

R₂ is linear or branched, unsubstituted or substituted C₈-C₂₂-alkyl or linear or branched, unsubstituted or substituted C₈-C₂₂ alkenyl;

AO is, identical or different, selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O or CH₂—CH(C₂H₅)—O,

a is a natural number from 1 to 30; and

b is a natural number from 1 to 30, with the proviso that 2≤a+b≤40;

(iii) alkoxylated triglyceride; and

c. at least one pesticide, or a salt thereof.

The term ‘aqueous’ denotes that the composition contains water.

The term “spray drift” is the movement of the pesticide through the air away from the intended target.

### Polymer P1)

In an embodiment, the aqueous composition comprises at least one Polymer P1).

The at least one polymer P1) is a polymerization reaction product of a monomer composition M1) comprising at least one monomer A).

The at least one monomer A) is selected from α,β-ethylenically unsaturated mono- and dicarboxylic acids, α,β-ethylenically unsaturated mono- and dicarboxylic 15 milacid esters, salts of α,β-ethylenically unsaturated mono- and dicarboxylic acids, anhydrides of α,β-ethylenically unsaturated mono- and dicarboxylic acids, amides of α,β-ethylenically unsaturated mono- and dicarboxylic acids, unsaturated sulfonic acids, salts of unsaturated sulfonic acids, unsaturated phosphonic acid, salts of unsaturated phosphonic acids and mixtures thereof.

As used herein, the term “polymer” generally denotes a molecule composed of multiple monomer units. It includes, but is not limited to, homopolymers, copolymers, such as for example, block, graft, random and alternating co-polymers. Furthermore, unless otherwise specifically limited, the term “polymer” shall include all possible isomeric configurations of the monomers, including, but are not limited to isotactic, syndiotactic and random symmetries configurations, and combinations thereof. Furthermore, unless otherwise specifically limited, the term “polymer” shall include all possible geometrical configurations of the molecule.

In an embodiment, the at least one monomer A) is selected from acrylic acid, methacrylic acid, ethacrylic acid, acrylamide, methacrylamide, N-methylacrylamide, N,N-dimethylacrylamide, N-ethylacrylamide, N,N-diethylacrylamide, N-methylmethacrylamide, N-methylol methacrylamide, N-ethylmethacrylamide, N,N-diethylmethacrylamide, N,N-dimethylmethacrylamide, N-phenylmethacrylamide, 2-acrylamido-2-methylpropane sulfonic acid, vinylsulfonic acid, allylsulfonic acid, sulfoethyl acrylate, sulfoethyl methacrylate, sulfopropyl acrylate, sulfopropyl methacrylate, 2-hydroxy-3-acryloxypropylsulfonic acid, 2-hydroxy-3-methacryl oxypropylsulfonic acid, styrenesulfonic acid, vinyl phosphonic acid, allyl phosphonic acid, sodium phosphinate, salts and mixtures thereof.

In a more preferred embodiment, the at least one monomer A) is selected from acrylic acid, methacrylic acid, ethacrylic acid, acrylamide, methacrylamide, N-methylacrylamide, N,N-dimethylacrylamide, N,N-dimethylmethacrylamide, N-methylol methacrylamide, 2-acrylamido-2-methylpropane sulfonic acid, vinylsulfonic acid, allylsulfonic acid, sulfoethyl acrylate, sulfoethyl methacrylate, sulfopropyl acrylate, sulfopropyl methacrylate, 2-hydroxy-3-acryloxypropylsulfonic acid, 2-hydroxy-3-methacryl oxypropylsulfonic acid, styrenesulfonic acid, vinyl phosphonic acid, allyl phosphonic acid, salts and mixtures thereof.

In a most preferred embodiment, the at least one monomer A) is selected from acrylic acid, methacrylic acid, acrylamide, methacrylamide, N-methylacrylamide, N,N-dimethylacrylamide, N-methylol methacrylamide, 2-acrylamido-2-methylpropane sulfonic acid, 2-hydroxy-3-acryloxypropylsulfonic acid, 2-hydroxy-3-methacryl oxypropylsulfonic acid, styrenesulfonic acid, salts and mixtures thereof.

In an embodiment, the monomer composition M1) further comprises at least one monomer B).

In another embodiment, the at least one monomer B) is a macromonomer.

Preferably, the at least one polymer P1) is a homopolymer or a copolymer.

In an embodiment the at least one Polymer P1) is a homopolymer.

The at least one polymer P1) is a polymerization reaction product of a monomer composition M1) comprising at least one monomer A).

In an embodiment, the at least one polymer P1) is a homopolymer or a copolymer of a monomer composition M1) comprising at least one monomer A).

In an embodiment, the at least one polymer P1) is a homopolymer of acrylic acid, methacrylic acid, salts of acrylic acid, salts of methacrylic acid, acrylamide, methacrylamide, salts of acrylamide and salts of methacrylamide.

In a preferred embodiment, the at least one polymer P1) is a homopolymer of acrylamide, referred to as Polymer ‘CP2’.

In an embodiment the at least one Polymer P1) is a copolymer of a monomer composition M1) comprising at least one monomer A).

In an embodiment, the at least one polymer P1) is a copolymer of acrylic acid, methacrylic acid, acrylamide, methacrylamide, N-methylacrylamide, N,N-dimethylacrylamide, N-methylol methacrylamide and 2-acrylamido-2-methylpropane sulfonic acid.

In a preferred embodiment, the at least one polymer P1) is a copolymer of acrylamide and 2-acrylamido-2-methylpropane sulfonic acid, referred to as Polymer ‘CP3’.

In another embodiment, the at least one polymer P1) is a polymerization reaction product of a monomer composition M1) comprising at least one monomer A) and at least one monomer B).

In another preferred embodiment, the at least one polymer P1) is a copolymer of at least one monomer A) and at least one macromonomer B) of general formula (IV)

H₂C═C(R₄)—R₅—O—(CH₂—CH₂—O—)ₖ—(CH₂—CH(R₆)—O—)ₗ—(CH₂—CH₂—O—)ₘR₇ (IV)

wherein

R₄ is H or methyl;

R₅ is independently a single bond or a divalent linking group chosen from —(CₙH₂ₙ)— and —O—(C_{n′}H_{2n′}), wherein n is from 1 to 6 and n′ is from 2 to 6;

R₆ is independently a hydrocarbyl radical having at least 2 carbon atoms or an ether group of the general formula —CH₂—O—R_{3′}, where R_{3′} is a hydrocarbyl radical having at least 2 carbon atoms;

R₇ is independently H or a hydrocarbyl radical having 1 to 4 carbon atoms

k is from 5 to 150;

l is from 0 to 25;

m is from 0 to 15;

In an embodiment, the at least one polymer P1) is a copolymer of at least one monomer A) selected from methacrylamide, N-methylacrylamide, N-methyl methacrylamide, N,N-dimethylacrylamide, N,N-dimethyl methacrylamide, N-methylol methacrylamide, 2-acrylamido-2-methylpropane sulfonic acid and at least one macromonomer B) of general formula (IV), referred to as Polymer “CP1”. The at least one macromonomer B) is as defined in the patent application US 2019/0110467 A1.

The weight average molecular weight (M_{w}) is determined by gel-permeation chromatography (GPC), Eluent 0.01 mol/l phosphate buffer, column set of 2 separating columns of column length 30 cm each, column temperature 35° C., pH=7.4, +0.01 M NaN₃ in deionized water. For calibration, polyacrylic acid (neutralized) standard is used. Flow rate is 0.8 mL/min, concentration 2 mg/mL, injection 100 μL. Detector: RID (Refractive Index Detector) Agilent 1200″.

The at least one polymer P1) has a weight average molecular weight (M_{w}) in the range of 1,000,000 g/mol to 15,000,000 g/mol as determined by gel-permeation chromatography (GPC).

In an embodiment, the at least one polymer P1) is present in an amount in the range of 0.0.005% to 5.0% by weight, based on the total weight of the aqueous composition.

### Additive

In an embodiment, the aqueous composition of the presently claimed invention comprises at least one additive.

The at least one additive is present in an amount in the range of 0.003% to 10% by weight, based on the total weight of the aqueous composition.

The at least one additive is selected from poly(C₂-C₄)alkylene glycol mono-(C₈-C₂₂)-carboxylic acid ester, alkoxylated alkylamine, alkoxylated triglyceride and combinations thereof.

The at least one additive is a poly(C₂-C₄)alkylene glycol mono-(C₈-C₂₂)-carboxylic acid ester of general formula (I),

R₁—CO-(AO)_{q}—H (I)

wherein

R₁ is linear or branched, unsubstituted or substituted C₈-C₂₂-alkyl, or linear or branched, unsubstituted or substituted C₈-C₂₂ alkenyl;

AO is identical or different, selected from CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O or CH₂—CH(C₂H₅)—O

q is a natural number from 1 to 40;

Within the context of the present invention, the term “alkyl” ₇ as used herein, refers to acyclic saturated aliphatic residues, including linear or branched alkyl residues. Furthermore, the alkyl residue includes as in the case of C₈-C₂₂ alkyl contain 8 to 22 carbon atoms.

For the purpose of the presently claimed invention, the term “alkenyl” covers acyclic unsaturated hydrocarbon residues, which may be linear or branched and unsubstituted or at least mono-substituted and comprise at least one double bond, preferably 1, 2 or 3 double bonds, with, as in the case of C₈-C₂₂ alkenyl, 8 to 22 (i.e. 8, 9, 10, 11, 12, 13, 14, 15, 16, 17, 18, 19, 20, 21, 22) carbon atoms. If one or more of the substituents denote an alkenyl residue which is mono- or polysubstituted, this may preferably be substituted with optionally 1, 2, 3, 4 or 5, particularly preferably with 1, 2 or 3, substituents mutually independently selected from the group consisting of F, Cl, Br, I, —NO₂, —CN, —OH, —SH, —NH₂, —N(C₁-C₅-alkyl)₂, —N(C₁-C₅-alkyl)(phenyl), —N(C₁-C₅-alkyl)(CH₂-phenyl), —N(C₁-C₅-alkyl)(CH₂—CH₂-phenyl), —C(═O)—H, —C(═O)—C₁-C₅-alkyl, —C(═O)-phenyl, —C(═S)—C₁-C₅-alkyl, —C(═S)-phenyl, —C(═O)—OH, —C(═O)—O—C₁-C₅-alkyl, —C(═O)—O—phenyl, —C(═O)—NH₂, —C(═O)—NH—C₁-C₅-alkyl, —C(═O)—N(C₁-C₅-alkyl)₂, —S(═O)—C₁-C₅-alkyl, —S(═O)-phenyl, —S(═O)₂—C₁-C₅-alkyl, —S(═O)₂-phenyl, —S(═O)₂—NH₂ and —SO₃H, wherein the above-stated-C₁-C₅ alkyl residues may in each case be linear or branched and the above-stated phenyl residues may preferably be substituted with 1, 2, 3, 4 or 5 substituents mutually independently selected from the group consisting of F, Cl, Br, I, —CN, —CF₃, —OH, —NH₂, —O—CF₃, —SH, —O—CH₃, —O—C₂H₅, —O—C₃H₇, methyl, ethyl, n-propyl, iso-propyl, n-butyl, 2-butyl, isobutyl and tert-butyl. Particularly preferred substituents may be selected mutually independently from the group consisting of F, Cl, Br, I, —NO₂, —CN, —OH, —SH, —NH₂, —N(CH₃)₂, —N(C₂H₅)₂ and —N(CH₃)(C₂H₅).

As used herein, “branched” denotes a chain of atoms with one or more side chains attached to it. Branching occurs by the replacement of a substituent, e.g., a hydrogen atom, with a covalently bonded aliphatic moiety.

Preferably, R₁ is linear, unsubstituted or substituted C₈-C₂₂-alkyl or linear and unsubstituted C₈-C₂₂ alkenyl.

Representative examples of linear and branched, unsubstituted or substituted C₈-C₂₂ alkyl include, but are not limited to n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl and 7-hydroxy heptadecyl.

Representative examples of linear, unsubstituted C₈-C₂₂ alkenyl include, but are not limited to octenyl, nonenyl, decenyl, undecenyl, dodecenyl, tridecenyl, tetradecenyl, pentadecenyl, hexadecenyl, heptadecenyl, octadecenyl, nonadecenyl, eicosenyl, heneicosenyl and docosenyl,

In a preferred embodiment, R₁ is selected from n-octyl, n-decyl, n-dodecyl, n-tetradecyl, n-hexadecyl, n-octadecyl, 7-hydroxy heptadecyl, decenyl and dodecenyl.

In a preferred embodiment, AO is CH₂—CH₂—O.

In an embodiment, q is a natural number in the range of 5 to 40, preferably in the range of 5 to 35. More preferably, q is a natural number in the range of 5 to 30, still more preferably in the range of 5 to 25. Most preferably, q is a natural number in the range of 5 to 25.

The at least one additive is an alkoxylated alkylamine of general formula (II)

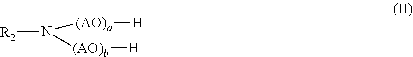

wherein

R₂ is linear or branched, substituted or unsubstituted C₈-C₂₂-alkyl or linear or branched, substituted or unsubstituted C₈-C₂₂-alkenyl,

AO is, identical or different, selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O or CH₂—CH(C₂H₅)—O,

a is a natural number from 1 to 30; and

b is a natural number from 1 to 30, with the proviso that 2≤a+b≤40;

Alkoxylated alkylamine of general formula (II) is synthesized by alkoxylation of a primary amine. The primary amine is generally derived from fatty acid amide by the thermal decomposition of the acid ammonium salt. The fatty acid in the fatty acid amide are derived from coconut, stearic, oleic and tallow, preferably tallow.

Tallow is extracted from the fatty deposits of animals. Animal fat is hydrolyzed to give a mixture of free fatty acids, typically oleic acid (37-43%), palmitic acid (24-32%), stearic acid (20-25%), myristic acid (3-6%), and linoleic acid (2-3%). They are converted to fatty amines via the nitrile process before being ethoxylated with ethylene oxide. Ethoxylated tallow amines are a mixture of compounds as the tallow itself is a mixture of fatty acids.

Preferably, R₂ is linear or branched, unsubstituted C₈-C₂₂-alkyl or linear or branched, unsubstituted C₈-C₂₂-alkenyl; AO is CH₂—CH₂—O, a is a natural number from 1 to 10; b is a natural number from 1 to 10, with the proviso that 2≤a+b≤20.

More preferably, alkoxylated alkylamine is an ethoxylated alkylamine

Preferably ethoxylated alkylamine is 2-propyl heptyl amine ethoxylate and tallow amine ethoxylate. l

In an embodiment, the at least one additive is an alkoxylated triglyceride.

In an embodiment, the alkoxylated triglyceride is a reaction product of triglyceride of general formula (III) and alkylene oxide

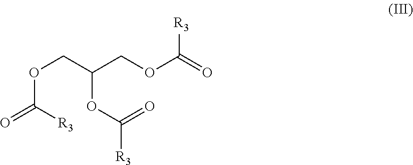

wherein

R₃ is linear or branched, substituted or unsubstituted C₈-C₂₂ alkyl, linear or branched, substituted or unsubstituted C₈-C₂₂ hydroxy alkyl, linear or branched, substituted or unsubstituted C₈-C₂₂-alkenyl or linear or branched, substituted or unsubstituted C₈-C₂₂-hydroxyalkenyl.

In an embodiment, triglyceride of general formula (III) is derived from castor oil. Castor oil is obtained from the seeds of Ricinus communis and consists primarily of the triglycerides of ricinoleic acid (about 90%), isoricinoleic, linoleic acid, oleic acid, stearic acid, palmitic acid, dihydroxystearic acid, linolenic acid and eicosanoic acid.

In an embodiment, the alkoxylated triglyceride is an alkoxylated derivative of castor oil or alkoxylated derivative of hydrogenated castor oil.

In an embodiment, the alkoxylated triglyceride has a hydrophilic/lipophilic balance (HLB) in the range of 6-16.

The HLB value represents the hydrophilic-lipophilic balance of the molecule. The lower the HLB value the more hydrophobic the material is, and vice versa. The HLB values can be calculated according to the method given in Griffin, J.Soc. Cosmetic Chemists, 5 (1954) 249-256.

Griffith's method for nonionic surfactants as described in 1954 is as follows:

HLB=20×Mₕ/M

where

Mₕ is the molecular mass of the hydrophilic portion of the molecule; and

M is the molecular mass of the whole molecule. Only the EO part in the surfactants is regarded as hydrophilic, all other parts contribute only to the whole molecule.

In a preferred embodiment, the alkoxylated triglyceride is an ethoxylated derivative of castor oil or an ethoxylated derivative of hydrogenated castor oil.

Ethoxylated castor oil is produced by the reaction of castor oil with ethylene oxide. Ethoxylated castor oil are of various chain lengths, depending on the quantity of ethylene oxide used during synthesis. The molar ratio can vary from 1 molecule of castor oil to 1-200 molecules of ethylene oxide, producing an ethoxylated castor oil named PEG-x (polyethylene glycol) castor oil, where x is the number of ethylene oxide moieties. In an embodiment, x is in the range of 10 to 100, preferably in the range of 10 to 50.

### Pesticides

A pesticide is defined as a substance that is used for preventing, destroying, repelling, regulating, and/or mitigating any pest. A pest is an organism that is deleterious to man or the environment but does not include any internal parasite of living man or other living animal or any fungus, bacterium, virus, or other microorganism on or in living man or other living animals. Said differently, the terminology “pest” does not typically include any organism that infects or sickens humans or animals. In addition, the terminology “pesticide,” as used herein, does not typically include any human or animal drugs or pharmaceuticals, any article that is a “new animal drug” as defined in the art, any liquid sterilant applied to a device used in the human body, and/or any products intended for use against fungi, bacteria, viruses, or other microorganisms in or on living man or living animal. Moreover, the pesticide of this disclosure does not typically include drugs or pharmaceuticals used to control diseases of humans or animals (such as livestock and pets).

The at least one pesticide is selected from fungicides, insecticides, nematicides and herbicides.

Mixtures of pesticides of two or more of the abovementioned classes may also be used.

Some pesticides useful with the present disclosure include, but are not limited to Acetylcholine esterase (AChE) inhibitors, carbamates (e.g. aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb and triazamate), organophosphates (e.g. acephate, azamethiphos, azinphos-ethyl, azinphosmethyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothio-phosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon and vamidothion) GABA-gated chloride channel antagonists, cyclodiene organochlorine compounds (e.g. endosulfan or chlordane), fiproles (phenylpyrazoles) (e.g. ethiprole, fipronil, flufiprole, pyrafluprole, and pyriprole), Sodium channel modulators from the class of pyrethroids (e.g. acrinathrin, allethrin, d-cis-trans allethrin, d-trans allethrin, bifenthrin, kappa-bifenthrin, bioallethrin, bioallethrin S-cylclopentenyl, bioresmethrin, cycloprothrin, cyfluthrin, betacyfluthrin, cyhalothrin, lambda-cyhalothrin, gamma-cyhalothrin, cypermethrin, alphacypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate,flumethrin, tau-fluvalinate, halfenprox, heptafluthrin, imiprothrin, meperfluthrin, metofluthrin, momfluorothrin, epsilonmomfluorothrin, permethrin, phenothrin, prallethrin, profluthrin, pyrethrin (pyrethrum), resmethrin, silafluofen, tefluthrin, kappa-tefluthrin, tetramethylfluthrin, tetramethrin, tralomethrin, and transfluthrin), sodium channel modulators (e.g. DDT or methoxychlor), Nicotinic acetylcholine receptor agonists (nAChR), neonicotinoids (e.g. acetamiprid, clothianidin, cycloxaprid, dinotefuran, imidacloprid, nitenpyram, thiacloprid and thiamethoxam), 4,5-Dihydro-N-nitro-1-(2-oxiranylmethyl)-1H-imidazol-2-amine, (2E-)-1-[(6-Chloropyridin-3-yl)methyl]-N′-nitro-2-pentylidenehydrazine carboximidamide, 1-[(6-Chloropyridin-3-yl)methyl]-7-methyl-8-nitro-5-propoxy-1,2,3,5,6,7-hexahydroimidazo[1,2-a]pyridine, nicotine, sulfoxaflor, flupyradifurone, triflumezopyrim, Nicotinic acetylcholine receptor allosteric activators, spinosyns (e.g. spinosad or spinetoram), Chloride channel activators from the class of avermectins and milbemycins (e.g. abamectin, emamectin benzoate, ivermectin, lepimectin, or milbemectin), Juvenile hormone mimics (e.g. juvenile hormone analogues hydroprene, kinoprene, and methoprene), fenoxycarb, pyriproxyfen, miscellaneous non-specific (multi-site) inhibitors (e.g. alkyl halides as methyl bromide and other alkyl halides), chloropicrin, sulfuryl fluoride, borax, tartar emetic, Chordotonal organ TRPV channel modulators (e.g. pymetrozine and pyrifluquinazon), Mite growth inhibitors (e.g. clofentezine, hexythiazox, and diflovidazin, or etoxazole), Microbial disruptors of insect midgut membranes (e.g. Bacillus thuringiensis or Bacillus sphaericus and the insecticidal proteins they produce such as Bacillus thuringiensis subsp. israelensis, Bacillus sphaericus, Bacillus thuringiensis subsp. aizawai, Bacillus thuringiensis subsp. kurstaki and Bacillus thuringiensis subsp. tenebrionis, or the Bt crop proteins: Cry1Ab, Cry1Ac, Cry1Fa, Cry2Ab, mCry3A, Cry3Ab, Cry3Bb, and Cry34/35Ab1), Inhibitors of mitochondrial ATP synthase (e.g. diafenthiuron or organotinmiticides such as azocyclotin, cyhexatin, fenbutatin oxide, propargite, tetra-difon), Uncouplers of oxidative phosphorylation via disruption of the proton gradient (e.g. chlorfenapyr, DNOC, or sulfluramid), Nicotinic acetylcholine receptor (nAChR) channel blockers (e.g. nereistoxin analogues bensultap, cartap hydrochloride, thiocyclam, or thiosultap sodium), Inhibitors of the chitin biosynthesis type 0 (e.g. benzoylureas e.g. bistrifluron, chlorfluazuron, diflubenzuron, flucycloxuron, flufenoxuron, hexaflumuron, lufenuron, novaluron, noviflumuron, teflubenzuron, or triflumuron), Inhibitors of the chitin biosynthesis type 1 (e.g. buprofezin), Moulting disruptors (e.g. Dipteran or cyromazine), Ecdyson receptor agonists (e.g. diacylhydrazines including methoxyfenozide, tebufenozide, halofenozide, fufenozide, or chromafenozide), Octopamin receptor agonists (e.g. amitraz), Mitochondrial complex III electron transport inhibitors (e.g. hydramethylnon, acequinocyl, fluacrypyrim, or bifenazate), Mitochondrial complex I electron transport inhibitors (e.g. METI acaricides and in-secticides such as fenazaquin, fenpyroximate, pyrimidifen, pyridaben, tebufenpyrad or tolfen-pyrad, or rotenone), Voltage-dependent sodium channel blockers (e.g. indoxacarb, metaflumizone, 2-[2-(4-Cyanophenyl)-1-[3-(trifluoromethyl)phenyl] ethylidene]-N-[4-(difluoromethoxy) phenyl]hydrazine carboxamide or N-(3-Chloro-2-methylphenyl)-2-[(4-chlorophenyl)[4-[methyl(methylsulfonyl)amino]phenyl]methylene]-hydrazine carboxamide), Inhibitors of acetyl CoA carboxylase (e.g. Tetronic and Tetramic acid derivatives, e.g. spirodiclofen, spiromesifen, spirotetramat, or spiropidion), Mitochondrial complex IV electron transport inhibitors (e.g. phosphine (such as aluminium phosphide, calcium phosphide, phosphine or zinc phosphide), or cyanide), Mitochondrial complex II electron transport inhibitors (e.g. betaketonitrile derivatives such as cyenopyrafen or cyflumetofen), Ryanodine receptor-modulators from the class of diamides (e.g. flubendiamide, chlor-antraniliprole, cyantraniliprole, tetraniliprole, (R)-3-Chlor-N1-{2-methyl-4-[1,2,2,2-tetrafluoro-1-(trifluoromethyl)ethyl] phenyl}-N2-(1-methyl-2-methylsulfonylethyl)phthalamid, (S)-3-Chloro-N1-{2-methyl-4-[1,2,2,2-tetrafluoro-1-(trifluoromethyl)ethyl]phenyl}-N2-(1-methyl-2-methylsulfonyl ethyl)phthalamid, cyclaniliprole, methyl-2-[3,5-dibromo-2-({[3-bromo-1-(3-chlorpyridin-2-yl)-1H-pyrazol-5-yl]carbonyl}amino)benzoyl]-1,2-dimethylhydrazinecarboxylate, N-[4,6-dichloro-2-[(diethyl-lambda-4-sulfanylidene)-carbamoyl]-phenyl]-2-(3-chloro-2-pyridyl)-5-(trifluoromethyl)pyrazole-3-carboxamide, N-[4-chloro-2-[(diethyl-lambda-4-sulfanylidene)carbamoyl]-6-methyl-phenyl]-2-(3-chloro-2-pyridyl)-5-(trifluoromethyl) pyrazole-3-carboxamide;) N-[4-chloro-2-[(di-2-propyl-lambda-4-sulfanylidene) carbamoyl]-6-methyl-phenyl]-2-(3-chloro-2-pyridyl)-5-(trifluoromethyl) pyrazole-3-carboxamide, N-[4,6-dichloro-2-[(di-2-propyl-lambda-4-sulfanylidene)carbamoyl]-phenyl]-2-(3-chloro-2-pyridyl)-5-(trifluoromethyl)pyrazole-3-carboxamide, N-[4,6-dibromo-2-[(diethyllambda-4-sulfanylidene)carbamoyl]-phenyl]-2-(3-chloro-2-pyridyl)-5-(trifluoromethyl) pyrazole-3-carboxamide, N-[2-(5-Amino-1,3,4-thiadiazol-2-yl)-4-chloro-6-methyl phenyl]-3-bromo-1-(3-chloro-2-pyridinyl)-1H-pyrazole-5-carboxamide, 3-Chloro-1-(3-chloro-2-pyridinyl)-N-[2,4-dichloro-6-[[(1-cyano-1-methylethyl)amino]carbonyl] phenyl]-1H-pyrazole-5-carboxamide, 3-Bromo-N-[2,4-dichloro-6-(methyl carbamoyl) phenyl]-1-(3,5-dichloro-2-pyridyl)-1H-pyrazole-5-carboxamide, or N-[4-Chloro-2-[[(1,1-dimethylethyl)amino]carbonyl]-6-methyl-phenyl]-1-(3-chloro-2-pyridinyl)-3-(fluoromethoxy)-1H-pyrazole-5-carboxamide), cyhalodiamide, Chordotonal organ Modulators having an undefined target site (e.g. flonicamid), insecticidal active compounds of unknown or uncertain mode of action (e.g. afidopyropen, afoxolaner, azadirachtin, amidoflumet, benzoximate, broflanilide, bromopropylate, chinomethionat, cryolite, dicloromezotiaz, dicofol, flufenerim, flometoquin, fluensulfone, fluhexafon, fluopyram, fluralaner, metaldehyde, metoxadiazone, piperonyl butoxide, pyflubumide, pyridalyl or tioxazafen), 11-(4-chloro-2,6-dimethylphenyl)-12-hydroxy-1,4-dioxa-9-azadispiro[4.2.4.2]-tetradec-11-en-10-one, 3-(4′-fluoro-2,4-dimethylbiphenyl-3yl)-4-hydroxy-8-oxa-1-azaspiro [4.5] dec-3-en-2-one, 1-[2-fluoro-4-methyl-5-[(2,2,2-trifluoroethyl)sulfinyl]phenyl]-3-(trifluoromethyl)-1H-1,2,4-triazole-5-amine, or actives on basis of bacillus firmus (Votivo, I-1582), flupyrimin, fluazaindolizine, 4-[5-(3,5-dichlorophenyl)-5-(trifluoromethyl)-4H-isoxazol-3-yl]-2-methyl-N-(1-oxothietan-3-yl)benzamide, fluxametamide,5-[3-[2,6-dichloro-4-(3,3-dichloroallyloxy)phenoxy]propoxy]-1H-pyrazole, 4-cyano-N-[2-cyano-5-[[2,6-dibromo-4-[1,2,2,3,3,3-hexafluoro-1-(trifluoromethyl)propyl]phenyl]carbamoyl]phenyl]-2-methyl-benzamide, 4-cyano-3-[(4-cyano-2-methyl-benzoyl)amino]-N-[2,6-dichloro-4-[1,2,2,3,3,3-hexafluoro-1-(trifluoromethyl)-propyl]phenyl]-2-fluoro-benzamide, N-[5-[[2-chloro-6-cyano-4-[1,2,2,3,3,3-hexafluoro-1-(trifluoromethyl)propyl]phenyl]carbamoyl]-2-cyano-phenyl]-4-cyano-2-methyl-benzamide, N-[5-[[2-bromo-6-chloro-4-[[2,2,2-trifluoro-1-hydroxy-1-(trifluoromethyl)ethyl]phenyl]carbamoyl]-2-cyano-phenyl]-4-cyano-2-methyl-benzamide, N-[5-[[2-bromo-6-chloro-4-[1,2,2,3,3,3-hexafluoro-1-(trifluoromethyl)-propyl]phenyl]carbamoyl]-2-cyano-phenyl]-4-cyano-2-methylbenzamide,4-cyano-N-[2-cyano-5-[[2,6-dichloro-4-[1,2,2,3,3,3-hexafluoro-1-(trifluoromethyl)-propyl]phenyl]carbamoyl]phenyl]-2-methyl-benzamide, 4-cyano-N-[2-cyano-5-[2,6-dichloro-4-[1,2,2,2-tetrafluoro-1-(trifluoromethyl) ethyl]phenyl]carbamoyl]phenyl]-2-methyl-benzamide, N-[5-[[2-bromo-6-chloro-4-[1,2,2,2-tetrafluoro-1-(trifluoromethyl)ethyl]phenyl] carbamoyl]-2-cyano-phenyl]-4-cyano-2-methyl-benzamide, 2-(1,3-Dioxan-2-yl)-6-[2-(3-pyridinyl)-5-thiazolyl]-pyridine, 2-[6-[2-(5-Fluoro-3-pyridinyl)-5-thiazolyl]-2-pyridinyl]-pyrimidine, 2-[6-[2-(3-Pyridinyl)-5-thiazolyl]-2-pyridinyl]-pyrimidine, N-Methylsulfonyl-6-[2-(3-pyridyl) thiazol-5-yl]pyridine-2-carboxamide, N-Methylsulfonyl-6-[2-(3-pyridyl)thiazol-5-yl]pyridine-2-carboxamide, 1-[(6-Chloro-3-pyridinyl)methyl]-1,2,3,5,6,7-hexahydro-5-methoxy-7-methyl-8-nitro-imidazo[1,2-a]pyridine, 1-[(6-Chloropyridin-3-yl)methyl]-7-methyl-8-nitro-1,2,3,5,6,7-hexahydroimidazo[1,2-a]pyridin-5-ol, 1-isopropyl-N,5-dimethyl-N-pyridazin-4-yl-pyrazole-4-carboxamide, 1-(1,2-dimethylpropyl)-N-ethyl-5-methyl-N-pyridazin-4-yl-pyrazole-4-carboxamide, N,5-dimethyl-N-pyridazin-4-yl-1-(2,2,2-trifluoro-1-methyl-ethyl)pyrazole-4-carboxamide, 1-[1-(1-cyanocyclopropyl)ethyl]-N-ethyl-5-methyl-N-pyridazin-4-yl-pyrazole-4-carboxamide, N-ethyl-1-(2-fluoro-1-methyl-propyl)-5-methyl-N-pyridazin-4-yl-pyrazole-4-carboxamide, 1-(1,2-dimethylpropyl)-N,5-dimethyl-N-pyridazin-4-yl-pyrazole-4-carboxamide, 1-[1-(1-cyanocyclopropyl)ethyl]-N,5-dimethyl-N-pyridazin-4-yl-pyrazole-4-carboxamide, N-methyl-1-(2-fluoro-1-methyl-propyl)-5-methyl-N-pyridazin-4-yl-pyrazole-4-carboxamide, 1-(4,4-difluorocyclohexyl)-N-ethyl-5-methyl-N-pyridazin-4-yl-pyrazole-4-carboxamide, 1-(4,4-difluorocyclohexyl)-N,5-dimethyl-N-pyridazin-4-yl-pyrazole-4-carboxamide, N-(1-methylethyl)-2-(3-pyridinyl)-2H-indazole-4-carboxamide, N-cyclopropyl-2-(3-pyridinyl)-2Hindazole-4-carboxamide, N-cyclohexyl-2-(3-pyridinyl)-2H-indazole-4-carboxamide, 2-(3-pyridinyl)-N-(2,2,2-trifluoroethyl)-2H-indazole-4-carboxamide, 2-(3-pyridinyl)-N-[(tetrahydro-2-furanyl)methyl]-2H-indazole-5-carboxamide, methyl-2-[[2-(3-pyridinyl)-2H-indazol-5-yl]carbonyl]hydrazine carboxylate, N-[(2,2-difluorocyclopropyl)methyl]-2-(3-pyridinyl)-2Hindazole-5-carboxamide, N-(2,2-difluoropropyl)-2-(3-pyridinyl)-2H-indazole-5-carboxamide, 2-(3-pyridinyl)-N-(2-pyrimidinylmethyl)-2H-indazole-5-carboxamide, N-[(5-methyl-2-pyrazinyl)methyl]-2-(3-pyridinyl)-2H-indazole-5-carboxamide, tyclopyrazoflor, sarolaner, lotilaner, N-[4-Chloro-3-[[(phenylmethyl)amino] carbonyl]phenyl]-1-methyl-3-(1,1,2,2,2-pentafluoroethyl)-4-(trifluoromethyl)-1H-pyrazole-5-carboxamide, 2-(3-ethylsulfonyl-2-pyridyl)-3-methyl-6-(trifluoromethyl) imidazo[4,5-b]pyridine, 2-[3-ethylsulfonyl-5-(trifluoromethyl)-2-pyridyl]-3-methyl-6-(trifluoromethyl)imidazo[4,5-b]pyridine, 4-[5-(3,5-dichlorophenyl)-5-(trifluoromethyl)-4H-isoxazol-3-yl]-N-[(4R)-2-ethyl-3-oxo-isoxazolidin-4-yl]-2-methyl-benzamide, 4-[5-(3,5-dichloro-4-fluoro-phenyl) -5-(trifluoromethyl)-4H-isoxazol-3-yl]-N-[(4R)-2-ethyl-3-oxo-isoxazolidin-4-yl]-2-methyl-benzamide, N-[4-chloro-3-(cyclopropylcarbamoyl)phenyl]-2-methyl-5-(1,1,2,2,2-pentafluoroethyl)-4-(trifluoromethyl)pyrazole-3-carboxamide, N-[4-chloro-3-[(1-cyanocyclopropyl)carbamoyl]phenyl]-2-methyl-5-(1,1,2,2,2-pentafluoroethyl)-4-(trifluoromethyl) pyrazole-3-carboxamide, acynonapyr, benzpy-rimoxan, 2-chloro-N-(1-cyanocyclopropyl)-5-[1-[2-methyl-5-(1,1,2,2,2-pentafluoroethyl)-4-(trifluoromethyl) pyrazol-3-yl]pyrazol-4-yl]benzamide, Oxazosulfyl, [(2S,3R,4R,5S,6S)-3,5-dimethoxy-6-methyl-4-propoxy-tetrahydropyran-2-yl] N-[4-[1-[4-(trifluoromethoxy)phenyl]-1,2,4-triazol-3-yl]phenyl]carbamate, [(2S,3R,4R,5S,6S)-3,4,5-trimethoxy-6-methyl-tetrahydropyran-2-yl] N-[4-[1-[4-(trifluoromethoxy)phenyl]-1,2,4-triazol-3-yl]phenyl]carbamate, [(2S,3R,4R,5S,6S)-3,5-dimethoxy-6-methyl-4-propoxy-tetrahydropyran-2-yl] N-[4-[1-[4-(1,1,2,2,2-pentafluoroethoxy)phenyl]-1,2,4-triazol-3-yl]phenyl]carbamate, [(2S,3R,4R,5S,6S)-3,4,5-trimethoxy-6-methyl-tetra hydropyran-2-yl] N-[4-[1-[4-(1,1,2,2,2-pentafluoroethoxy)phenyl]-1,2,4-triazol-3-yl]phenyl]carbamate, (2Z)-3-(2-isopropylphenyl)-2-[(E)-[4-[1-[4-(trifluoromethoxy) phenyl]-1,2,4-triazol-3-yl]phenyl]methylenehydrazono]thiazolidin-4-one, (2Z)-3-(2-isopropylphenyl)-2-[(E)-[4-[1-[4-(1,1,2,2,2-pentafluoroethoxy)phenyl]-1,2,4-triazol-3-yl]phenyl]methylenehydrazono]thiazolidin-4-one.

Other pesticides include, but are not limited to respiration inhibitors, inhibitors of complex III at Qo site (e.g. azoxystrobin, coumethoxystrobin, coumoxystrobin, dimoxystrobin, enestroburin, fenaminstrobin, fenoxystrobin/flufenoxystrobin, fluoxastrobin, kresoxim-methyl, mandestrobin, metominostrobin, orysastrobin, picoxystrobin, pyra-clostrobin, pyrametostrobin, pyraoxystrobin, trifloxystrobin, 2 (2-(3-(2,6-dichlorophenyl)-1-methylallylideneaminooxymethyl)-phenyl)-2 methoxy imino-N methyl acetamide, pyribencarb, triclopyricarb/chlorodincarb, fa-moxadone, fenamidone, methyl-N-[2-[(1,4-dimethyl-5 phenylpyrazol-3-yl)oxylmethyl]phenyl]-N-methoxy-carbamate, 1-[2-[[1-(4-chlorophenyl)pyrazol-3-yl]oxy-methyl]-3-methyl-phenyl]-4-methyl-tetrazol-5-one, (Z,2E) 5 [1-(2,4-dichlorophenyl)pyrazol-3-yl]-oxy-2-methoxyimino-N,3-dimethyl-pent-3-enamide, (Z,2E) 5 [1 (4-chlorophenyl)pyrazol-3-yl]oxy-2-methoxyimino-N,3-dimethyl-pent-3-enamide, pyriminostrobin, bifujunzhi, or 2-(ortho-((2,5-dimethylphenyl-oxymethylen)phenyl)-3-methoxyacrylicacid methyl ester), inhibitors of complex III at Qi site (e.g. cyazofamid, amisulbrom, [(6S,7R,8R) 8 benzyl-3-[(3-hydroxy-4-methoxy-pyridine-2-carbonyl)amino]-6-methyl-4,9-dioxo-1,5-dioxonan-7-yl] 2-methylpropanoate, or fenpicoxamid), inhibitors of complex II (e.g. benodanil, benzovindiflupyr, bixafen, bos-calid, carboxin, fenfuram, fluopyram, flutolanil, fluxapyroxad, furametpyr, isofetamid, isopyrazam, mepronil, oxycarboxin, penflufen, penthiopyrad, pydiflumetofen, pyraziflumid, sedaxane, tecloftalam, thifluzamide, inpyrfluxam, pyrapropoyne, fluindapyr, methyl (E)-2-[2-[(5-cyano-2-methyl-phenoxy)methyl]phenyl]-3-methoxy-prop-2enoate, isoflucypram, 2-(difluoromethyl)—N-(1,1,3-trimethyl-indan-4-yl)pyridine-3-carboxamide, 2-(difluoromethyl)-N-[(3R)-1,1,3-trimethylindan-4-yl]pyridine-3-carboxamide, 2-(difluoromethyl)-N-(3-ethyl-1,1-dimethyl-indan-4-yl)pyridine-3-carboxamide, 2-(difluoromethyl)-N-[(3R)-3-ethyl-1,1-dimethyl-indan-4-yl]pyridine-3-carboxamide, 2-(difluoromethyl)-N-(1,1-dimethyl-3-propyl-indan-4-yl)pyridine-3-carboxamide, 2-(difluoromethyl)-N-[(3R)-1,1-dimethyl-3-propyl-indan-4-yl]pyridine-3-carboxamide, 2-(difluoromethyl)-N-(3-isobutyl-1,1-dimethyl-indan-4-yl)pyridine-3-carboxamide, or 2-(difluoromethyl)-N-[(3R)-3-isobutyl-1,1-dimethyl-indan-4 yl]pyridine-3-carboxamide, other respiration inhibitors (e.g. diflumetorim, nitrophenyl derivates, binapacryl, dinobuton, dinocap, fluazinam, meptyldinocap, ferimzone, organometal compounds, fentin salts (e. g. fentinacetate, fentin chloride, or fentin hydroxide), ametoctradin, silthiofam, sterol biosynthesis inhibitors (SBI fungicides), C14 demethylase inhibitors, triazoles, azaconazole, bitertanol, bromuconazole, cyproconazole, difenoconazole, diniconazole, diniconazole-M, epoxiconazole, fenbuconazole, fluquinconazole, flusi-lazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, 2 (2,4-difluorophenyl)-1,1-difluoro-3-(tetrazol-1-yl)-1-[5-[4-(2,2,2-trifluoroethoxy)phenyl]-2-pyridyl]propan-2-ol, 2-(2,4-difluorophenyI)-1,1-difluoro-3-(tetrazol-1-yl)-1 [5 [4-(trifluoromethoxy)phenyl]-2-pyridyl]propan-2-ol, ipfentrifluconazole, mefentrifluconazole, 2-(chloromethyl)-2-methyl-5-(p-tolylmethyl)-1(1,2,4-triazol-1 ylmethyl)cyclopentanol, imidazoles, imazalil, pefurazoate, prochloraz, triflumizol, pyrimidines, pyridines, piperazines, fenarimol, pyrifenox, triforine, [3-(4-chloro-2-fluoro-phenyl)-5-(2,4-difluorophenyl) isoxazol-4-yl]-(3-pyridyl)methanol, Delta-14-reductase inhibitors, aldimorph, dodemorph, dodemorphacetate, fenpropimorph, tridemorph, fenpropidin, piperalin, spirox-amine, inhibitors of 3-ketoreductase, fenhexamid, other sterol biosynthesis inhibitors, chlorphenomizole, nucleic acid synthesis inhibitors, phenylamides or acyl amino acid fungicides, benalaxyl, benalaxyl-M, kiralaxyl, metalaxyl, metalaxyl-M, ofurace, oxadixyl, other nucleic acid synthesis inhibitors, hymexazole, octhilinone, oxolinic acid, bupirimate, 5-fluorocytosine, 5-fluoro-2-(ptolylmethoxy)pyrimidin-4 amine, 5-fluoro-2-(4-fluorophenylmethoxy)pyrimidin-4 amine, 5-fluoro-2 (4 chlorophenylmethoxy)pyrimidin-4 amine, inhibitors of cell division and cytoskeleton, tubulin inhibitors, benomyl, carbendazim, fuberidazole, thia-bendazole, thiophanate-methyl, 3-chloro-4-(2,6-difluorophenyl)-6-methyl-5-phenyl-pyridazine, 3-chloro-6-methyl-5-phenyl-4-(2,4,6-trifluorophenyl)pyridazine, N ethyl-2-[(3-ethynyl-8-methyl-6-quinolyl)oxy]butanamide, N-ethyl-2-[(3-ethynyl-8-methyl-6-quinolyl)oxy]-2-methyl sulfanyl acetamide, 2-[(3-ethynyl-8-methyl-6-quinol-yl)oxy]-N(2-fluoroethyl)butanamide, 2-[(3-ethynyl-8-methyl-6-quinolyl)oxy]-N-(2-flu-oroethyl)-2-methoxy-acetamide, 2-[(3-ethynyl-8-methyl-6-quinolyl)oxy]-N-propyl-butanamide, 2-[(3-ethynyl-8-methyl-6-quinolyl)oxy]-2-methoxy-N-propyl-acetamide, 2-[(3-ethynyl-8-methyl-6-quinolyl)oxy]-2-methylsulfanyl-N-propylacetamide, 2-[(3-ethynyl-8-methyl-6-quinolyl)oxy]-N-(2-fluoroethyl)-2-methylsulfanylacetamide, 4-(2-bromo-4-fluoro-phenyl)-N-(2-chloro-6-fluoro-phenyl)-2,5-dimethyl-pyrazol-3-amine, other cell division inhibitors, diethofencarb, ethaboxam, pencycuron, fluopicolide, zoxamide, metrafenone, pyriofenone, inhibitors of amino acid and protein synthesis, methionine synthesis inhibitors, cyprodinil, mepanipyrim, pyrimethanil, protein synthesis inhibitors, blasticidin-S, kasugamycin, kasugamycin hydrochloride-hydrate, mildiomycin, streptomycin, oxytetracyclin, signal transduction inhibitors, MAP/histidine kinase inhibitors, fluoroimid, iprodione, procymidone, vinclozolin, fludioxonil, G protein inhibitors, quinoxyfen, lipid and membrane synthesis inhibitors, phospholipid biosynthesis inhibitors, edifenphos, iprobenfos, pyrazophos, isoprothiolane, lipid peroxidation, dicloran, quintozene, tecnazene, tolclofos-methyl, biphenyl, chloroneb, etridiazole, phospholipid biosynthesis and cell wall deposition, dimethomorph, flumorph, mandipropamid, pyrimorph, benthiavalicarb, iprovalicarb, valifenalate, compounds affecting cell membrane permeability and fatty acids, propamocarb, inhibitors of oxysterol binding protein, oxathiapiprolin, 2-{3-[2-[1-{[3,5-bis(difluoro-methyl-1H pyrazol-1-yl]acetyl}piperidin-4-yl)-1,3-thiazol-4-yl]-4,5-dihydro-1,2 oxazol-5-yl}phenylmethanesulfonate, 2-{3-[2-(1-({[3,5-bis(difluoromethyl)-1H-pyrazol-1-yl]-acetyl}piperidin-4-yl)1,3-thiazol-4-yl]-4,5-dihydro-1,2-oxazol-5 yl}-3-chlorophenyl methane-sulfonate, 4-[1-[2-[3-(difluoromethyl)-5-methyl-pyrazol-1yl]acetyl]-4-piperidyl]-N-tetralin-1-yl-pyridine-2-carboxamide, 4-[1-[2-[3,5-bis(difluoromethyl) pyrazol-1-yl]acetyl]-4-piperidyl]-N-tetralin-1-ylpyridine-2-carboxamide, 4-[1-[2-[3-(difluoromethyl)-5-(tri-fluoromethyl)pyrazol-1-yl]acetyl]-4-piperidyl]-N-tetralin-1-yl-pyridine-2-carboxamide, 4-[1-[2-[5-cyclopropyl-3-(difluoromethyl)pyrazol-1-yl]acetyl]-4-piperidyl]-N-tetralin-1-yl-pyridine-2-carboxamide, 4-[1-[2-[5-methyl-3-(trifluoromethyl)pyrazol-1-yl]acetyl]-4-piperidy]-N-tetralin-1-yl-pyridine-2-carboxamide, 4-[1-[2-[5-(difluoromethyl)-3-(trifluoro-methyl)pyrazol-1-yl]acetyl]-4-piperidyl]-N-tetralin-1-yl-pyridine-2-carboxamide, 4 [1 [2-[3,5-bis(trifluoromethyl) pyrazol-1-yl]acetyl]-4-piperidyl]-N-tetralin-1-yl-pyridine-2-carboxamide, (4-[1-[2-[5-cyclopropyl-3-(trifluoromethyl)pyrazol-1-yl]acetyl]-4-piperidyl]-N-tetralin-1-yl-pyridine-2-carboxamide, inhibitors with multi-site action, inorganic active substances, bordeaux mixture, copper, copper acetate, copper hydroxide, copper oxychloride, basic copper sulfate, sulfur, thio- and dithiocarbamates, ferbam, mancozeb, maneb, metam, metiram, propineb, thiram, zineb, ziram, organochlorine compounds, anilazine, chlorothalonil, captafol, captan, folpet, dichlofluanid, dichlorophen, hexachlorobenzene, pentachlorphenole and its salts, phthalide, tolylfluanid, guanidines and others, guanidine, dodine, dodine free base, guazatine, guazatine-acetate, iminoctadine, iminoctadine-triacetate, iminoctadine-tris(albesilate), dithianon, 2,6-dimethyl-1H,5H-[1,4]di-thiino[2,3-c:5,6-c′]dipyrrole-1,3,5,7(2H,6H)-tetraone, cell wall synthesis inhibitors, inhibitors of glucan synthesis, validamycin, polyoxin B, melanin synthesis inhibitors, pyroquilon, tricyclazole, carpropamid, di-cyclomet, fenoxanil, plant defense inducers, acibenzolar-S-methyl, probenazole, isotianil, tiadinil, prohexa-dione-calcium, phosphonates, fosetyl aluminum, phosphorous acid and its salts, calcium phosphonate, potassium phosphonate, potassium or sodium bicarbonate, 4-cyclopropyl-N-(2,4-dimethoxyphenyl)thiadiazole-5-carboxamide, bronopol, chinomethionat, cyflufenamid, cymoxanil, dazomet, debacarb, diclocymet, diclomezine, difenzoquat, di-fenzoquat-methylsulfate, diphenylamin, fenitropan, fenpyrazamine, flumetover, flusulfamide, flutianil, harpin, metha-sulfocarb, nitrapyrin, nitrothalisopropyl, tolprocarb, oxin-copper, proquinazid, tebufloquin, tecloftalam, triazoxide, N′-(4-(4-chloro-3-trifluoromethyl-phenoxy)-2,5-dimethyl-phenyl)-N-ethyl-N methyl formamidine, N′ (4-(4-fluoro-3-trifluoromethyl-phenoxy)-2,5-dimethyl-phenyl)-N-ethyl-N-methyl formamidine, N′-[4-[[3-[(4-chlorophenyl) methyl]-1,2,4-thiadiazol-5-yl]oxy]-2,5-dimethyl-phenyl]-N-ethyl-N-methyl formamidine, N′-(5-bromo-6-indan-2-yloxy-2-methyl-3-pyridyl)-N-ethyl-N-methylformamidine, N′-[5-bromo-6-[1-(3,5-difluorophenyl)ethoxy]-2-methyl-3-pyridyl]-N-ethyl-N-methyl-formamidine, N′-[5-bromo-6-(4-isopropylcyclohexoxy)-2-methyl-3-pyridyl]-N-ethyl-N methyl-formamidine, N′ [5 bromo-2-methyl-6-(1-phenylethoxy)-3-pyridyl]-N-ethyl-N-methylformamidine, N′-(2-methyl-5-trifluoromethyl-4-(3-trimethyl silanyl-propoxy)-phenyl)-N-ethyl-N-methyl formamidine, N′-(5-difluoromethyl-2 methyl-4-(3-trimethylsilanyl-propoxy)-phenyl)-N-ethyl-N-methyl formamidine, 2-(4-chloro-phenyl)-N-[4-(3,4-dimethoxy-phenyl)-isoxazol-5-yl]-2-prop-2-ynyloxy acetamide, 3-[5-(4-chloro-phenyl)-2,3-dimethyl-isoxazolidin-3-yl]-pyridine (pyrisoxazole), 3-[5-(4-methylphenyl)-2,3-dimethyl-isoxazolidin-3-yl]-pyridine, 5-chloro-1-(4,6-dimethoxy-pyrimidin-2-yl)-2-methyl-1H-benzoimidazole, ethyl (Z) 3 amino-2-cyano-3-phenyl-prop-2-enoate, picarbutrazox, pentyl N-[6-[[(Z)-[(1-methyltetrazol-5-yl)-phenyl-methylene]amino]oxymethyl]-2-pyridyl]carbamate, but-3-ynyl N-[6-[[(Z)-[(1-methyltetrazol-5-yl)-phenyl-methylene]amino]oxymethyl]-2-pyridyl]carbamate, 2-[2-[(7,8-difluoro-2-methyl-3-quinolyl)oxy]-6-fluoro-phenyl]propan-2-ol, 2-[2-fluoro-6-[(8-fluoro-2-methyl-3-quinolyl)oxy]phen-yl]propan-2-ol, quinofumelin, 9-fluoro-2,2-dimethyl-5-(3-quinolyI)-3H 1,4-benzoxazepine, 2-(6-benzyl-2-pyridyl)quinazoline, 2-[6-(3-fluoro-4 methoxy-phenyl)-5-methyl-2-pyridyl]quinazoline, dichlobentiazox, N′-(2,5-dimethyl-4-phenoxy-phenyl)-N-ethyl-N-methylformamidine, and pyrifenamine.

Still further instances of pesticides include, but are not limited to microbial pesticides with fungicidal, bactericidal, viricidal and/or plant defence activator activity, Ampelomyces quisqualis, Aspergillus flavus, Aureobasidium pullulans, Bacillus altitudinis, B. amyloliquefaciens, B. megaterium, B. mojavensis, B. mycoides, B. pumilus, B. simplex, B. solisalsi, B. subtilis, B. subtilis var. amyloliquefaciens, Candida oleophila, C. saitoana, Clavibacter michiganensis (bacteriophages), Coniothyrium minitans, Cryphonectria parasitica, Cryptococcus albidus, Dilophosphora alopecuri, Fusarium oxysporum, Clonostachys rosea f. catenulate (also named Gliocladium catenulatum), Gliocladium roseum, Lysobacter antibioticus, L. enzymogenes, Metschnikowia fructicola, Microdochium dimerum, Microsphaeropsis ochracea, Muscodor albus, Paenibacillus alvei, Paenibacillus epiphyticus, P. polymyxa, Pantoea vagans, Penicillium bilaiae, Phlebiopsis gigantea, Pseudomonas sp., Pseudomonas chloraphis, Pseudozyma flocculosa, Pichia anomala, Pythium oligandrum, Sphaerodes mycoparasitica, Streptomyces griseoviridis, S. lydicus, S. violaceusniger, Talaromyces flavus, Trichoderma asperelloides, T. asperellum, T. atroviride, T. fertile, T. gamsii, T. harmatum, T. harzianum, T. polysporum, T. stromaticum, T. virens, T. viride, Typhula phacorrhiza, Ulocladium oudemansii, Verticillium dahlia, zucchini yellow mosaic virus (avirulent strain), biochemical pesticides with fungicidal, bactericidal, viricidal and/or plant defense activator activity, harpin protein, Reynoutria sachalinensis extract, microbial pesticides with insecticidal, acaricidal, molluscidal and/or nematicidal activity, Agrobacterium radiobacter, Bacillus cereus, B. firmus, B. thuringiensis, B. thuringiensis ssp. aizawai, B. t. ssp. israelensis, B. t. ssp. galleriae, B. t. ssp. kurstaki, B. t. ssp. tenebrionis, Beauveria bassiana, B. brongniartii, Burkholderia spp., Chromobacterium subtsugae, Cydia pomonella granulovirus (CpGV), Cryptophlebia leucotreta granulovirus (CrleGV), Flavobacterium spp., Helicoverpa armigera nucleopolyhedrovirus (HearNPV), Helicoverpa zea nucleopolyhedrovirus (HzNPV), Helicoverpa zea single capsid nucleopolyhedrovirus (HzSNPV), Heterorhabditis bacteriophora, Isaria fumosorosea, Lecanicillium longisporum, L. muscarium, Metarhizium anisopliae, M. anisopliae var. anisopliae, M. anisopliae var. acridum, Nomuraea rileyi, Paecilomyces fumosoroseus, P. lilacinus, Paenibacillus popilliae, Pasteuria spp., P. nishizawae, P. penetrans, P. ramosa, P. thornea, P. usgae, Pseudomonas fluorescens, Spodoptera littoralis nucleopolyhedrovirus (SpliNPV), Steinernema carpocapsae, S. feltiae, S. kraussei, Streptomyces galbus, S. microflavus, biochemical pesticides with insecticidal, acaricidal, molluscidal, pheromone and/or nematicidal activity, L-carvone, citral, (E,4-7,9-dodecadien-1-yl acetate, ethyl formate, (E,4-2,4-ethyl decadienoate (pear ester), (Z,Z,E)-7,11,13-hexadecatrienal, heptyl butyrate, isopropyl myristate, lavanulyl senecioate, cis-jasmone, 2-methyl 1-butanol, methyl eugenol, methyl jasmonate, (E,4-2,13-octadecadien-1-ol, (E,4-2,13-octadecadien-1-ol acetate, (E,4-3,13-octadecadien-1-ol, (R)-1-octen-3-ol, pentatermanone, (E,Z,Z-3,8,11-tetradecatrienyl acetate, (Z,E)-9,12-tetradecadien-1-yl acetate, (7)-7-tetradecen-2-one, (4-9-tetradecen-1-yl acetate, (4-11-tetradecenal, (4-11-tetradecen-1-ol, extract of Chenopodium ambrosiodes, Neem oil, Quillay extract, microbial pesticides with plant stress reducing, plant growth regulator, plant growthpromoting and/or yield enhancing activity, Azospirillum amazonense, A. brasilense, A. lipoferum, A. irakense, A. halopraeferens, Bradyrhizobium spp., B. elkanii, B. japonicum, B. liaoningense, B. lupini, Delftia acidovorans, Glomus intraradices, Mesorhizobium spp., Rhizobium leguminosarum bv. phaseoli, R. l. bv. trifolii, R. l. bv. viciae, R. tropici, and Sinorhizobium meliloti.

Further instances of pesticides can be found in a variety of locations including The Pesticide Manual, 17th Edition, C. MacBean, British Crop Protection Council (2015) (the teachings and contents of which are incorporated by reference herein). The Pesticide Manual is updated regularly and is accessible online at the bcpc data website. Another online data base for pesticides providing the ISO common names is found online at the alanwood.net website.

In an embodiment, the pesticide is a fungicide. In a further embodiment, the pesticide is a herbicide. In yet a further embodiment, the pesticide is an insecticide. In another embodiment, the pesticide is a strobilurine. In one embodiment, the pesticide is a fungicide or herbicide or insecticide. In another embodiment, the pesticide is a fungicide or herbicide. In still another embodiment, the pesticide is glyphosate or a salt thereof, strobilurine, glufosinate or a salt thereof and/or triclopyr-2-butoxyethyl ester.

In various embodiments, the pesticide is glyphosate (e.g. commercially available as Roundup® PowerMax from Bayer Crop Scienceo), In another embodiment, the pesticide is pyraclostrobin (commercially available as Headline® from BASF). In a further embodiment, the pesticide is triclopyr-2-butoxyethyl ester (commercially available as Remedy Ultra® from Dow AgroSciences). In another embodiment, the pesticide is glufosinate (commercially available as Liberty® from BASF SEe). In an additional embodiment, the pesticide is a combination of two or more of the aforementioned compounds.

The pesticide may be present in the aqueous composition in any amount, e.g. as specified by the product label. The pesticide is, for example, present in the aqueous composition in amounts from about 0.01 to about 85, 0.1 to about 60, 1 to about 20, about 1 to about 8, weight percent based on a total weight of the aqueous composition. In other embodiments, the pesticide is present in an amount (or in an amount equivalent to) from 1 to 1000, from 10 to 900, from 100 to 800, from 400 to 700, from 500 to 600, or about 400, grams of pesticide per liter. In various non-limiting embodiments, all values and ranges of values between and including the aforementioned values are hereby expressly contemplated. In various embodiments, any one or more of the aforementioned amount(s) may vary by ±1, 2, 3, 4, 5, 6, 7, 8, 9, or 10, %.

### Water

The composition also includes water. The water may be of any type, e.g. tap water, well water, purified water, deionized water, and combinations thereof and may be present in varying amounts. The water may be added to the at least one polymer P1) and/or the at least one pesticide to form the composition in a spray tank or in an independent tank prior to addition to a spray tank. In various embodiments the at least one pesticide and/or the at least one polymer P1) may be added to an independent container and/or a spray tank with spray water or separate from the spray water.

In an embodiment, water is present in an amount in the range of 60% to 99% by weight, based on the total weight of the aqueous composition.

In an embodiment, the aqueous composition may further comprise solvents, liquid carriers, surfactants, dispersants, emulsifiers, wetters, adjuvants, solubilizers, penetration enhancers, protective colloids, adhesion agents, thickeners, humectants, repellents, attractants, feeding stimulants, compatibilizers, anti-freezing agents, anti-foaming agents, colorants, tackifiers and binders.

The suitable solvents and liquid carriers are organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzyl alcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides and mixtures thereof.

In an embodiment of the present invention, the suitable surfactants are surface-active compounds such as anionic, cationic, non-ionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

In an embodiment of the present invention, the suitable anionic surfactants are alkali, alkaline earth or ammonium salts of sulfonates, sulphates, phosphates, carboxylates, and mixtures thereof. Examples of sulfonates are alkylaryl sulfonates, diphenyl sulfonates, alpha-olefin sulfonates, lignin sulfonates, sulfonates of fatty acids and oils, sulfonates of ethoxylated alkyl phenols, sulfonates of alkoxylated aryl phenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulphates are sulphates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkyl phenol ethoxylate.

In an embodiment of the present invention, the suitable non-ionic surfactants are alkoxylates, N-substituted fatty acid amides, amine oxides, esters, sugar-based surfactants, polymeric surfactants, and mixtures thereof. Examples of alkoxylates are compounds such as alcohols, alkyl phenols, amines, amides, aryl phenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are homo or copolymers of vinylpyrrolidone, vinyl alcohols, or vinyl acetate.

In an embodiment of the present invention, the cationic surfactants are quaternary surfactants, for example quaternary ammonium compounds with one or two hydrophobic groups, or salts of long-chain primary amines. Suitable amphoteric surfactants are alkylbetaines and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of poly-acrylic acid or polyacid comb polymers. Examples of polybases are polyvinyl amines or polyethylene amines.

In an embodiment of the present invention, the thickeners are polysaccharides (e.g. xanthan gum, carboxymethylcellulose), inorganic clays (organically modified or unmodified), polycarboxylates, and silicates.

In an embodiment of the present invention, the anti-freezing agents are ethylene glycol, propylene glycol, urea and glycerine.

In an embodiment of the present invention, the anti-foaming agents are silicones, long chain alcohols and salts of fatty acids.

In an embodiment of the present invention, the colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

### Spray Drift Performance

In an embodiment, the aqueous composition of the present invention is typically applied through a spray nozzle onto a target, such as a plant. The aqueous composition is typically atomized under pressure by various engineered nozzles to form spray droplets. In various embodiments, the percentage of droplets having a diameter less than, for example, 105 to 250 microns, are described as “fines.” The optimum droplet size tends to depend on the application. If droplets are too large, there will be less coverage by the spray. The maximum acceptable droplet size may depend on the amount of the aqueous composition being applied per unit area and the mode of action of the pesticide active ingredient. Smaller droplets provide more even coverage but are more prone to drift during spraying. If it is windy during spraying, larger droplets may be preferred, whereas on a calmer day smaller droplet may be preferred. In addition, spray droplet size may also depend on the spray apparatus; e.g. spray nozzle size and type, height from target, and configuration.

In an embodiment of the present invention, the aqueous composition of the present invention shows a reduced volume percent of droplets having a diameter less than 105, 110, 115, 120, 125, 130, 135, 140, 145, 150, 155 or 160 microns, as determined using ASTM E2798-11 and a Malvern Spray Tech droplet analyser. In other embodiments, less than 70, 65, 60, 55, 50, 45, 40, 35, 30, 25, 20, 15, 10, 5, 4, 3, 2, or 1, percent of the droplets have a diameter of less than 105, 110, 115, 120, 125, 130, 135, 140, 145, 150, 155, or 160, microns, upon spraying, as determined using ASTM E2798-11 and a Malvern Spray Tech droplet analyser. In various embodiments, the aqueous compositions of the disclosure show an average fines reduction of, 90, 80, 70, 60, 50, 40, 30, or 20 percent, as determined using ASTM E2798-11 and a Malvern Spray Tech droplet analyser and, for example, a nozzle such as a TTI11004-VP TeeJet Spray Tip Nozzle. In other words, in various embodiments, a small percentage of the droplets have small diameters, which is typically desirable because this results in less spray drift. In various non-limiting embodiments, all values and ranges of values between and including the aforementioned values are hereby expressly contemplated.

In another embodiment of the present invention, the aqueous composition produces fines % V<105 μm of less than 15, upon spraying, as determined using ASTM E2798-11 and a Malvern Spray Tech droplet analyser and a TeeJet 8002VS nozzle. In another embodiment, the aqueous agricultural composition produces fines % V<105 μm of less than 10, upon spraying, as determined using ASTM E2798-11 and a Malvern Spray Tech droplet analyser and a TeeJet 8002VS nozzle. In a further embodiment, the aqueous composition produces fines % V<105 μm of less than 5, upon spraying, as determined using ASTM E2798-11 and a Malvern Spray Tech droplet analyzer and a TeeJet 8002VS nozzle. In one embodiment, the aqueous composition produces fines %V <105 μm of less than 2, upon spraying, as determined using ASTM E2798-11 and a Malvern Spray Tech droplet analyser and a TT111004-VP TeeJet Spray Tip Nozzle.

In an aspect of the present invention, the aqueous composition exhibits shear stability. Shear stability indicates that the aqueous composition maintains its ability to reduce driftable fines even after being subjected to shear forces change in the viscosity when subjected to repeated shear forces. The composition is said to be shear stable, if upon spraying of said aqueous composition to form droplets, less than 5% of said droplets have volume mean diameter (VMD) of <141 μm as determined using ASTM E 2798-11, a Malvern Spray Tech droplet analyser, and a TTI11004-VP TeeJet Spray Tip Nozzle. In the present case, the shear forces are applied when the aqueous composition passes through the spray pump. The at least one additive stabilizes the at least one polymer P1) and thus renders the aqueous composition shear stable.

In some forms, the reduced effects of shear on the at least one polymer P1) can be determined by an increased or maintained stability in the droplet size formed under shear conditions, in comparison to an aqueous composition that is not combined with an additive as described herein.

Advantageously, the method and aqueous composition reduces the effect of the shear conditions that decrease the droplet size and thereby increase the drift of the desired components of the aqueous composition.

Such an effect is attributed to the increased stability of the at least one polymer P1) due to the addition of the at least one additive. Use of the at least one additive provides shear stability possibly by maintaining the hydrodynamic volume of the at least one polymer P1) and maintains the droplet size.

In yet another aspect, the presently claimed invention is directed to the use of the aqueous composition, as described above, for controlling spray drift.

In another aspect, the presently claimed invention is directed to a kit of parts comprising, as separate components, (a) the at least one Polymer P1); b) the at least one additive and c) the at least one pesticide.

In another aspect, the present invention is directed to a method of forming an aqueous composition comprising the steps of combining at least one polymer P1), at least one additive (b) and at least one pesticide (c).

The aforementioned components and compounds may be added in any order to one or more of each other and in any amount and in one or more individual steps, e.g. in whole or in parts.

In an embodiment of the present invention, a method of applying the aqueous composition to an agricultural target wherein the method includes the step of spraying the aqueous composition. The agricultural target may be any known in the art of pesticide applications and may be, for examples, weeds, crops, fields, plants, etc. In one embodiment, the agricultural target is a weed. In another embodiment, the agricultural target is a crop. In a further embodiment, the agricultural target is a field. In another embodiment, the agricultural target is a plant. In a further embodiment, the agricultural target is turf. In yet another embodiment, the agricultural target is a horticultural target. Moreover, the agricultural target may be grass or a field or a pasture. The agricultural target may be associated with a residential or commercial application.

In an embodiment of the present invention, the method of applying the aqueous composition comprises spraying the aqueous composition onto a tract of land either prior to planting an agricultural crop or pre- or post-harvest of an agricultural crop.

Moreover, the step of spraying may utilize a spray nozzle and may be further defined to include any parameters known in the art of spraying pesticides. The spray nozzle may be any known in the art such as TTI11004-VP TeeJet Spray Tip Nozzle or any other suitable nozzle as would be recognized by one of skill in the art.

The aqueous composition of the present invention offers one or more of following advantages:

1. Reduced spray drift fines and off-target movement of pesticide applications compared to current available formulations, while maintaining use friendly handling and use characteristics, and without adversely affecting their pesticidal activity. 2. The aqueous composition exhibits shear stability.

In the following, specific embodiments of the present invention are described:

1. An aqueous composition comprising
a. at least one polymer P1) that is a polymerization reaction product of a monomer composition M1) comprising at least one monomer A) selected from α,β-ethylenically unsaturated mono- and dicarboxylic acids, α,β-ethylenically unsaturated mono- and dicarboxylic acid esters, salts of α,β-ethylenically unsaturated mono- and dicarboxylic acids, anhydrides of α,β-ethylenically unsaturated mono- and dicarboxylic acids, amides of α,β-ethylenically unsaturated mono- and dicarboxylic acids, unsaturated sulfonic acids, salts of unsaturated sulfonic acids, unsaturated phosphonic acid, salts of unsaturated phosphonic acids and mixtures thereof,
b. at least one additive selected from the group of
   (i) poly(C₂-C₄)alkylene glycol mono-(C₈-C₂₂)-carboxylic acid ester of general formula (I)

R₁—CO-(AO)_{q}—H (I)
wherein
R₁ is linear or branched, unsubstituted or substituted C₈-C₂₂-alkyl or linear or branched, unsubstituted or substituted C₈-C₂₂ alkenyl;
AO is identical or different, selected from CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O or CH₂—CH(C₂H₅)—O
q is a natural number from 1 to 40; and
   (ii) alkoxylated alkylamine of general formula (II)

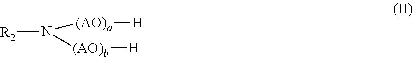

wherein
R₂ is linear or branched, unsubstituted or substituted C₈-C₂₂-alkyl or linear or branched, unsubstituted or substituted C₈-C₂₂ alkenyl;
AO is identical or different, selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O or CH₂—CH(C₂H₅)—O,
a is a natural number from 1 to 30; and
b is a natural number from 1 to 30, with the proviso that 2≤a+b≤40; and
   (iii) alkoxylated triglyceride; and
c. at least one pesticide, or a salt thereof.

2. The aqueous composition according to embodiment 1, wherein the at least one monomer A) is selected from acrylic acid, methacrylic acid, ethacrylic acid, acrylamide, methacrylamide, N-methylacrylamide, N,N-dimethylacrylamide, N-ethylacrylamide, N₇N-diethylacrylamide, N-methylmethacrylamide, N-methylol methacrylamide, N-ethylmethacrylamide, N,N-diethylmethacrylamide, N,N-dimethylmethacrylamide, N-phenylmethacrylamide, 2-acrylamido-2-methylpropane sulfonic acid, vinylsulfonic acid, allylsulfonic acid, sulfoethyl acrylate, sulfoethyl methacrylate, sulfopropyl acrylate, sulfopropyl methacrylate, 2-hydroxy-3-acryloxypropylsulfonic acid, 2-hydroxy-3-methacryloxypropylsulfonic acid, styrenesulfonic acid, vinyl phosphonic acid, allyl phosphonic acid, sodium phosphinate, salts and mixtures thereof.

3. The aqueous composition according to embodiment 1, wherein the monomer composition M1) further comprises at least one monomer B).

4. The aqueous composition according to embodiment 3, wherein the at least one monomer B) is a macromonomer of the general formula (IV)

H₂C═C(R₄)—R₅—O—(CH₂—CH₂—O—)ₖ—(CH₂—CH(R₆)—O—)ₗ—(CH₂—CH₂—O—)ₘR₇ (IV)

wherein

R₄ is H or methyl;

R₅ is independently a single bond or a divalent linking group chosen from —(CₙH₂ₙ)— and —O—(C_{n′}H_{2n′}), wherein n is from 1 to 6 and n′ is from 2 to 6;

R₆ is independently a hydrocarbyl radical having at least 2 carbon atoms or an ether group of the general formula —CH₂—O—R_{3′}, where R_{3′} is a hydrocarbyl radical having at least 2 carbon atoms;

R₇ is independently H or a hydrocarbyl radical having 1 to 4 carbon atoms

k is from 5 to 150;

l is from 0 to 25;

m is from 0 to 15;

5. The aqueous composition according to one or more of embodiments 1 wherein the at least one polymer P1) has a weight average molecular weight in the range of 1,000,000 g/mol to 15,000,000 g/mol determined according to gel permeation chromatography.

6. The aqueous composition according to embodiment 1, wherein the at least one polymer P1) is a homopolymer or a copolymer.

7. The aqueous composition according to embodiment 6, wherein the at least one polymer P1) is a homopolymer or a copolymer of acrylic acid, methacrylic acid, salts of acrylic acid, salts of methacrylic acid, acrylamide, methacrylamide, salts of acrylamide and salts of methacrylamide.

8. The aqueous composition according to embodiment 6, wherein the at least one polymer P1) is a copolymer of acrylamide and 2-acrylamido-2-methylpropane sulfonic acid.

9. The aqueous composition according to embodiment 6, wherein the at least one polymer P1) is a copolymer of at least one monomer A) and at least one macromonomer B).

10. The aqueous composition according to embodiment 1, wherein R₁ is selected from n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl, 7-hydroxy heptadecyl, octenyl, nonenyl, decenyl, undecenyl, dodecenyl, tridecenyl, tetradecenyl, pentadecenyl, hexadecenyl, heptadecenyl, octadecenyl, nonadecenyl, eicosenyl, heneicosenyl and docosenyl.

11. The aqueous composition according to embodiment 1, wherein AO is CH₂—CH₂—O.

12. The aqueous composition according to embodiment 1, wherein the alkoxylated triglyceride is a reaction product of triglyceride of general formula (III) and alkylene oxide

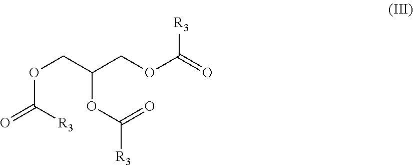

wherein

R₃ is linear or branched, substituted or unsubstituted C₈-C₂₂ alkyl, linear or branched, substituted or unsubstituted C₈-C₂₂ hydroxy alkyl, linear or branched, substituted or unsubstituted C₈-C₂₂-alkenyl, or linear or branched, substituted or unsubstituted C₈-C₂₂-hydroxyalkenyl.

13. The aqueous composition according to embodiment 12, wherein the alkoxylated triglyceride is an alkoxylated derivative of castor oil or alkoxylated derivative of hydrogenated castor oil.

14. The aqueous composition according to embodiment 11 or 12, wherein the alkoxylated triglyceride has a hydrophilic/lipophilic balance in the range of 6-16.

15. The aqueous composition according to one or more of embodiments 1 to 14, wherein the at least one polymer P1) is present in an amount of 0.005% to 5.0% by weight of the total weight of the composition.

16. The aqueous composition according to one or more of embodiments 1 to 15, wherein the at least one additive is present in an amount of 0.003% to 10.0% by weight based on the total weight of the composition.

17. The aqueous composition according to one or more of embodiments 1 to 16, wherein the at least one pesticide is present in an amount of 0.001% to 50.0% by weight based on the total weight of the composition.

18. The aqueous composition according to one or more of embodiments 1 to 17, wherein water is present in an amount of 60.0% to 99.0% by weight based on the total weight of the composition.

19. A shear stable aqueous composition according to one or more of embodiments 1 to 18 wherein upon spraying of said aqueous composition to form droplets, less than 5% of said droplets have volume mean diameter (VMD) of <141 μm as determined using ASTM E 2798-11, a Malvern Spray Tech droplet analyser, and a TTI11004-VP TeeJet Spray Tip Nozzle. 20. A method of forming an aqueous composition according to one or more of embodiments 1 to 19, comprising the step of combining at least one polymer P1), at least one additive (b) and at least one pesticide (c).

21. A method for reducing spray drift, the method comprising spraying an aqueous composition according to one or more of embodiments 1 to 19 onto a tract of land either prior to planting an agricultural crop or pre- or post-harvest of said agricultural crop.

22. Use of the aqueous composition according to one or more of embodiments 1 to 19 for controlling spray drift.

23. An agricultural kit comprising, as separate components, (a) the at least one Polymer P1); (b) the at least one additive, and (c) the at least one pesticide as defined according to one or more of embodiments 1 to 19.

While the presently claimed invention has been described in terms of its specific embodiments, certain modifications and equivalents will be apparent to those skilled in the art and are intended to be included within the scope of the presently claimed invention.

### EXAMPLES

The presently claimed invention is illustrated in detail by non-restrictive working examples which follow. More particularly, the test methods specified hereinafter are part of the general disclosure of the application and are not restricted to the specific working examples.

### Compounds

| PS 1 | RoundUp PowerMax ® Herbicide |
|---|---|
| | which is a 1.7%-v/v aqueous |
| | solution of a 48.7% potassium |
| | glyphosate herbicide formulation |
| is available from Bayer Crop Science | |
| CP 3 | A co-polymer of acrylamide |
| | monomer and AMPS (2- |
| | Acrylamido-2-Methylpropane |
| | sulfonic Acid) monomer |
| Additive 1 | Polyethoxylated tallow amine |
| | (5 EO) |
| Additive 2 | Polyethoxylated tallow amine |
| | (20 EO) |
| Additive 3 | Ethoxylated 2-Propylheptylamine |
| | (2 EO) |
| Additive 4 | Ethoxylated castor oil (16 EO) |
| Additive 5 | Ethoxylated castor oil (25 EO) |
| Additive 6 | Ethoxylated castor oil (40 EO) |
| Additive 7 | Ethoxylated 12-Hydroxystearic |
| | (15 EO) acid |
| Additive 8 | PEG 400 Monolaurate |
| Additive 9 | PEG 600 Monooleate |

are available from BASF SE.

### Methods

All drift efficacy testing was done in conformance with the U.S. E.P.A. Generic Verification Protocol for Testing Pesticide Application Spray Drift Reduction Technologies for Row and Field Crops as set forth in the June, 2016 Final Generic Verification Protocol for Pesticide Spray DRT.

### Measurement of Driftable Fines

The examples test the effect of different additives at a 0.5% and 1.0% by weight inclusion level with the pesticide solution PS1 and with or without polymer CP3 when cycled 5 times through the pump and subsequently sprayed through the TTI 11004 nozzle at a pressure of 63 psi for the droplet analysis. The parameters and results with different additives are provided in Table-1 below:

TABLE-1

| | | | | | | Driftable Fines (% V < 141μ) | | | | |
|---|---|---|---|---|---|---|---|---|---|---|
| | | Additive | | Polymer | | Pump Passes | | | | |
| Example no. | Additive | concentration | Polymer | concentration | Pesticide | 0 | 1 | 3 | 5 | Δ % V |
| 1 | None | — | None | — | PS 1 | 2.15 | 2.79 | 3.04 | 2.80 | 0.65 |
| 2 | None | — | CP 3 | 0.625 | PS 1 | 1.33 | 2.51 | 2.41 | 2.31 | 0.98 |
| 3 | Additive 1 | 1.00% | CP 3 | 0.625 | PS 1 | 0.63 | 1.78 | 1.59 | 2.31 | 1.68 |
| 4 | Additive 2 | 1.00% | CP 3 | 0.625 | PS 1 | 0.04 | 0.29 | 0.37 | 0.84 | 0.80 |
| 5 | Additive 3 | 1.00% | CP 3 | 0.625 | PS 1 | 1.13 | 0.78 | 1.35 | 1.49 | 0.36 |
| 6 | Additive 1 | 1.00% | None | — | PS 1 | 4.11 | 3.26 | 2.86 | 3.26 | -0.45 |
| 7 | Additive 4 | 1.00% | CP 3 | 0.625 | PS 1 | 1.18 | 1.70 | 1.94 | ND | 0.76 |
| 8 | Additive 5 | 1.00% | CP 3 | 1.000 | PS 1 | 0.98 | 1.53 | 1.62 | ND | 0.64 |
| 9 | Additive 6 | 1.00% | CP 3 | 0.625 | PS 1 | 1.18 | 3 | 1.95 | ND | 0.77 |
| 10 | Additive 5 | 1.00% | None | — | PS 1 | 2.22 | 2.31 | 2.21 | ND | -0.01 |
| 11 | Additive 7 | 1.00% | CP 3 | 0.625 | PS 1 | 0.76 | 1.10 | 1.81 | 1.99 | 1.23 |
| 12 | Additive 7 | 0.50% | CP 3 | 0.625 | PS 1 | 1.42 | 1.99 | 2.02 | 2.20 | 0.78 |
| 13 | Additive 7 | 1.00% | None | — | PS 1 | 2.15 | 2.68 | 1.99 | 2.41 | 0.26 |
| 14 | Additive 8 | 1.00% | CP 3 | 0.625 | PS 1 | 1.10 | 1.66 | 2.20 | ND | 1.10 |
| 15 | Additive 9 | 1.00% | CP 3 | 0.625 | PS 1 | 0.65 | 1.14 | 1.59 | ND | 0.94 |
| 16 | Additive 10 | 1.00% | None | — | PS 1 | 2.40 | 2.42 | 2.46 | ND | 0.06 |

As shown by the data in Table-1, the aqueous compositions of examples 3, 4, 5, 7, 8, 9, 11, 12, 14 and 15 containing an additive experienced less variation in droplet size as evidenced by the lower percentage of droplets that had a volume less than 141μm at each successive pass through the pump system. Droplet size of the pesticide solution alone (with no additives) was unaffected by the shear conditions. The additives alone without polymer as in examples 6, 10, 13 and 16, do not reduce driftable fines when compared to the solution alone with no additives (example 1 and 2). The additives are not performing as drift reduction agents, rather the examples show they are solely stabilizing the drift reduction performance of the polymer (CP 3) from the affects of shear from the pump.

1. An aqueous composition comprising
a. at least one polymer P1) that is a polymerization reaction product of a monomer composition M1) comprising at least one monomer A) selected from the group consisting of α,β-ethylenically unsaturated mono- and dicarboxylic acids, α,β-ethylenically unsaturated mono- and dicarboxylic acid esters, salts of α,β-ethylenically unsaturated mono- and dicarboxylic acids, anhydrides of α,β-ethylenically unsaturated mono- and dicarboxylic acids, amides of α,β-ethylenically unsaturated mono- and dicarboxylic acids, unsaturated sulfonic acids, salts of unsaturated sulfonic acids, unsaturated phosphonic acid, salts of unsaturated phosphonic acids and mixtures thereof;
b. at least one additive selected from the group consisting of
(i) poly(C₂-C₄)alkylene glycol mono-(C₈-C₂₂)-carboxylic acid ester of general formula (I)
R₁—CO-(AO)_{q}—H (I)
wherein
R₁ is linear or branched, unsubstituted or substituted C₈-C₂₂-alkyl or linear or branched, unsubstituted or substituted C₈-C₂₂ alkenyl;
AO is identical or different, selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O
q is a natural number from 1 to 40;
(ii) alkoxylated alkylamine of general formula (II) 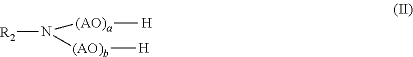
wherein
R₂ is linear or branched, unsubstituted or substituted C₈-C₂₂-alkyl or linear or branched, unsubstituted or substituted C₈-C₂₂ alkenyl;
AO is, identical or different, selected from the group consisting of CH₂—CH₂—O, CH(CH₃)—CH₂—O, CH₂—CH(CH₃)—O, CH(C₂H₅)—CH₂—O, C(CH₃)₂—CH₂—O, CH₂C(CH₃)₂—O and CH₂—CH(C₂H₅)—O,
a is a natural number from 1 to 30; and
b is a natural number from 1 to 30, with the proviso that 2≤a+b≤40; and
(iii) alkoxylated triglyceride; and
c. at least one pesticide, or a salt thereof.

2. The aqueous composition according to claim 1, wherein the at least one monomer A) is selected from the group consisting of acrylic acid, methacrylic acid, ethacrylic acid, acrylamide, methacrylamide, N-methylacrylamide, N,N-dimethylacrylamide, N-ethylacrylamide, N,N-diethylacrylamide, N-methylmethacrylamide, N-methylol methacrylamide, N-ethylmethacrylamide, N,N-diethylmethacrylamide, N,N-dimethylmethacrylamide, N-phenylmethacrylamide, 2-acrylamido-2-methylpropane sulfonic acid, vinyl sulfonic acid, allyl sulfonic acid, sulfoethyl acrylate, sulfoethyl methacrylate, sulfopropyl acrylate, sulfopropyl methacrylate, 2-hydroxy-3-acryloxypropylsulfonic acid, 2-hydroxy-3 -methacryloxypropyl sulfonic acid, styrenesulfonic acid, vinyl phosphonic acid, allyl phosphonic acid, sodium phosphinate, salts and mixtures thereof.

3. The aqueous composition according to claim 1, wherein the monomer composition M1) further comprises at least one monomer B).

4. The aqueous composition according to claim 3, wherein the at least one monomer B) is a macromonomer of the general formula (IV)
H₂C═C(R₄)—R₅—O—(CH₂—CH₂—O—)ₖ—(CH₂—CH(R₆)—O—)ₗ—(CH₂—CH₂—O—)ₘR₇ (IV)
wherein
R₄ is H or methyl;
R₅ is independently a single bond or a divalent linking group selected from the group consisting of
—(CₙH₂ₙ)— and —O—(C_{n′}H_{2n′}), wherein n is from 1 to 6 and n′ is from 2 to 6;
R₆ is independently a hydrocarbyl radical having at least 2 carbon atoms or an ether group of the general formula —CH₂—O—R_{3′}, wherein R_{3′} is a hydrocarbyl radical having at least 2 carbon atoms;
R₇ is independently H or a hydrocarbyl radical having 1 to 4 carbon atoms;
k is from 5 to 150;
l is from 0 to 25; and
m is from 0 to 15.

5. The aqueous composition according to claim 1 wherein the at least one polymer P1) has a weight average molecular weight in the range of 1,000,000 g/mol to 15,000,000 g/mol determined according to gel permeation chromatography.

6. The aqueous composition according to claim 1, wherein the at least one polymer P1) is a homopolymer or a copolymer.

7. The aqueous composition according to claim 6, wherein the at least one polymer P1) is a homopolymer or a copolymer of acrylic acid, methacrylic acid, salts of acrylic acid, salts of methacrylic acid, acrylamide, methacrylamide, salts of acrylamide, or salts of methacrylamide.

8. The aqueous composition according to claim 6, wherein the at least one polymer P1) is a copolymer of acrylamide and 2-acrylamido-2-methylpropane sulfonic acid.

9. The aqueous composition according to claim 6, wherein the at least one polymer P1) is a copolymer of at least one monomer A) and at least one macromonomer B).

10. The aqueous composition according to claim 1, wherein R₁ is selected from the group consisting of n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, n-heneicosyl, n-docosyl, isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoeicosyl, isoheneicosyl, isodocosyl and 7-hydroxy heptadecyl.

11. The aqueous composition according to claim 1, wherein AO is CH₂—CH₂—O.

12. The aqueous composition according to claim 1, wherein the alkoxylated triglyceride is a reaction product of alkylene oxide and a triglyceride of general formula (III) 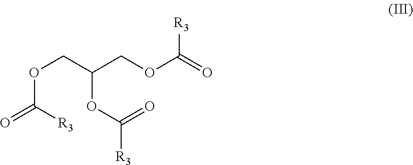
wherein
R₃ is linear or branched, substituted or unsubstituted C₈-C₂₂ alkyl, linear or branched, substituted or unsubstituted C₈-C₂₂ hydroxy alkyl, linear or branched, substituted or unsubstituted C₈-C₂₂-alkenyl, or linear or branched, substituted or unsubstituted C₈-C₂₂-hydroxyalkenyl.

13. The aqueous composition according to claim 12, wherein the alkoxylated triglyceride is an alkoxylated derivative of castor oil or alkoxylated derivative of hydrogenated castor oil.

14. The aqueous composition according to claim 12, wherein the alkoxylated triglyceride has a hydrophilic/lipophilic balance in the range of 6-16.

15. The aqueous composition according to e claim 1, wherein the at least one polymer P1) is present in an amount of 0.005% to 5.0% by weight of the total weight of the composition.

16. The aqueous composition according to claim 1, wherein the at least one additive is present in an amount of 0.003% to 10.0% by weight based on the total weight of the composition.

17. The aqueous composition according to claim 1, wherein the at least one pesticide is present in an amount of 0.001% to 50.0% by weight based on the total weight of the composition.

18. The aqueous composition according to claim 1, wherein water is present in an amount of 60.0% to 99.0% by weight based on the total weight of the composition.

19. A shear stable aqueous composition according to claim 1, wherein upon spraying of said aqueous composition to form droplets, less than 5% of said droplets have volume mean diameter (VMD) of <141 μm as determined using ASTM E2798-11, a Malvern Spray Tech droplet analyser, and a TTI11004-VP TeeJet Spray Tip Nozzle.

20. A method of forming an aqueous composition according to claim 1, comprising the step of combining at least one polymer P1), at least one additive (b), and at least one pesticide (c).

21. A method for reducing spray drift, the method comprising spraying an aqueous composition according to claim 1 onto a tract of land either prior to planting an agricultural crop or pre- or post-harvest of said agricultural crop.

22. A method of using the aqueous composition according to claim 1, the method comprising using the aqueous composition for controlling spray drift.

23. An agricultural kit comprising, as separate components, (a) the at least one Polymer P1), (b) the at least one additive, and (c) the at least one pesticide according to claim 1.
